(19) United States
(12) Patent Application Publication
(10) Pub. No.: US 2013/0205025 A1
(43) Pub. Date: Aug. 8, 2013

(54) Optimized Virtual Private Network Routing Through Multiple Gateways

(71) Applicants: Navaid Shamsee, Dubai (AE); Adam Nasr El Din, Dubai (AE)

(72) Inventors: Navaid Shamsee, Dubai (AE); Adam Nasr El Din, Dubai (AE)

(73) Assignee: Cisco Technology, Inc., San Jose, CA (US)

(21) Appl. No.: 13/367,975

(22) Filed: Feb. 7, 2012

(51) Int. Cl. G06F 15/16

(52) U.S. Cl. 709/225

(57) ABSTRACT

In one embodiment, a secure communication tunnel is established between a first VPN gateway and a remote access client. The remote access client requests a resource of an enterprise network. The first VPN gateway selects a second VPN gateway based at least on a cost of communication between the requested resource and the second VPN gateway. An indication of the second VPN gateway is sent to the remote access client. The first VPN gateway maintains the first secure communication tunnel while the remote access client accesses the resource through a second secure communication tunnel established between the remote access client and the second VPN gateway.

### TECHNICAL FIELD

The present disclosure relates generally to communications networking and more specifically to optimized virtual private network routing through multiple VPN gateways.

### BACKGROUND

An enterprise network may include a plurality of resources. A remote access client may access the enterprise network through one or more virtual private network (VPN) gateways. Each VPN gateway may offer secure access to the resources of the enterprise network. A remote access client may establish a secure communication tunnel with a VPN gateway and communicate with the resources of the enterprise network through the secure communication tunnel.

### BRIEF DESCRIPTION OF THE DRAWINGS

For a more complete understanding of the present disclosure and its features and advantages, reference is now made to the following description, taken in conjunction with the accompanying drawings, in which:

FIG. 1 depicts an example system comprising Virtual Private Network (VPN) gateways that perform VPN routing;

FIG. 2A depicts example local route lists that may be generated by the VPN gateways of FIG. 1;

FIG. 2B depicts an example global route list that may be generated by a VPN gateway of the system of FIG. 1; and

FIG. 3 depicts an example method that may performed by the VPN gateways of the system of FIG. 1.

### DESCRIPTION OF EXAMPLE EMBODIMENTS

### Overview

According to one embodiment, a method includes receiving a request from a remote access client to establish a first secure communication tunnel with a first Virtual Private Network (VPN) gateway of a plurality of VPN gateways of an enterprise network. Each VPN gateway may be operable to provide secure access to the same subset of a plurality of resources of the enterprise network. The first secure communication tunnel is established between the remote access client and the first VPN gateway. The method may further include receiving, through the first secure communication tunnel, a request from the remote access client to access a first resource of the subset of resources of the enterprise network. A second VPN gateway may be selected from the plurality of VPN gateways based at least on a cost of communication between the first resource and the second VPN gateway. The first VPN gateway sends an indication of the second VPN gateway to the remote access client and maintains the first secure communication tunnel while the remote access client accesses the first resource of the enterprise network through a second secure communication tunnel established between the remote access client and the second VPN gateway.

Certain embodiments of the disclosure may provide one or more technical advantages. A technical advantage of one embodiment is that a VPN gateway may choose an optimal VPN gateway to provide a resource of an enterprise network to a remote access client. Another technical advantage of one embodiment is that a VPN gateway that is closest to a resource may provide the resource to a remote access client.

Certain embodiments of the disclosure may include none, some, or all of the above technical advantages. One or more other technical advantages may be readily apparent to one skilled in the art from the figures, descriptions, and claims included herein.

### Description

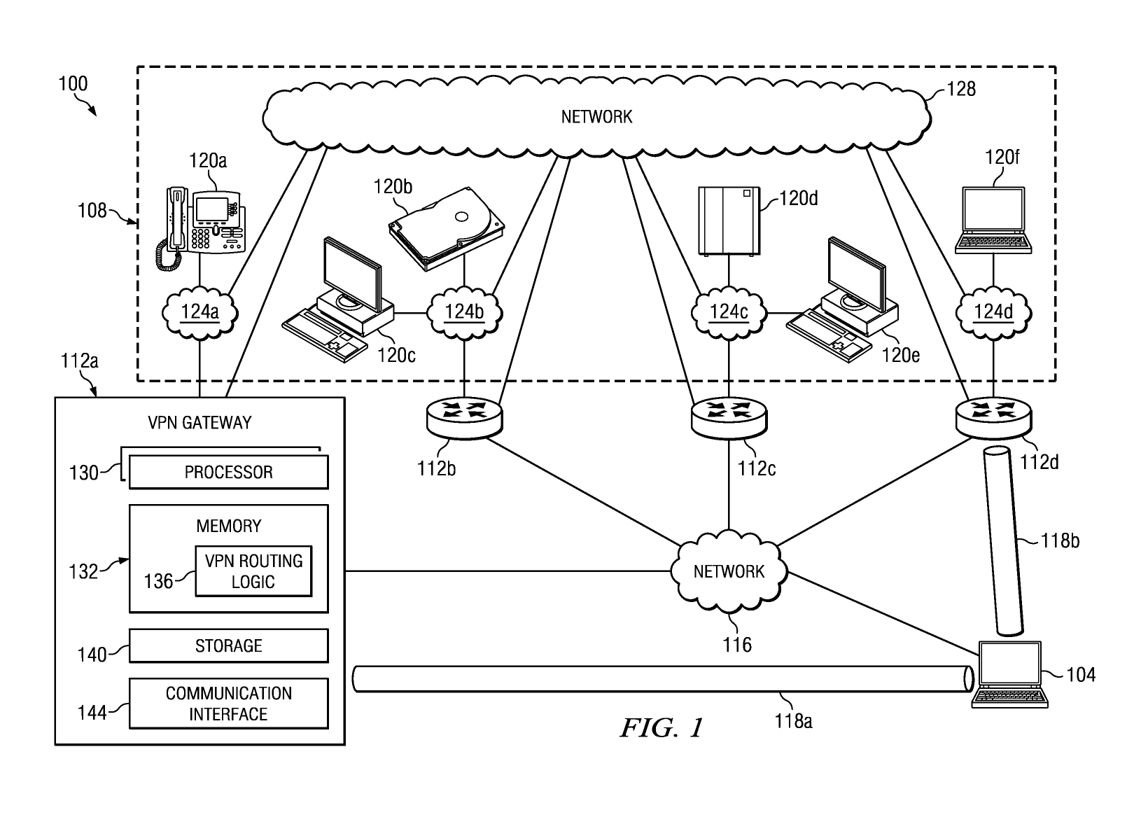

FIG. 1 depicts an example system 100 comprising Virtual Private Network (VPN) gateways 112 that perform optimized VPN routing for a remote access client 104. In the embodiment depicted, system 100 includes four VPN gateways 112 coupled to a remote access client 104 through network 116. The VPN gateways 112 are also coupled to various resources 120 of an enterprise network 108 through networks 128 and 124. In the embodiment shown, remote access client 104 is operable to access enterprise network 108 through VPN tunnels 118 formed between remote access client 104 and VPN gateways 112.

A user associated with an enterprise may use VPN functionality to securely connect to the enterprise's network 108 and access applications and services provided by resources 120. The user may be able to securely access resources 120 over a public network 116, such as the Internet, through a VPN tunnel 118. A VPN tunnel may be established through network 116 between a remote access client 104 and VPN gateway 112 after the user undergoes an authentication and authorization process with a VPN gateway 112.

Some large enterprises have multiple VPN gateways 112 that each provide access to enterprise network 108. These VPN gateways 112 are often geographically distributed to provide redundancy, high availability, and optimal paths to the enterprise network 108. In such systems, a user may manually indicate a particular VPN gateway to connect to or may allow software to choose the VPN gateway used to access the enterprise network. Typical systems generally assume that the optimal path to resources within an enterprise network is the closest VPN gateway to the remote access client and will thus connect to this VPN gateway unless the user specifies a different VPN gateway. After establishing a connection to the closest VPN gateway, the remote access client generally uses the same VPN gateway to access all requested resources of the enterprise network. Such systems do not consider the optimality of the path between the VPN gateway and the resource. For example, a user traveling from location A to location B may connect to the VPN gateway of location B to access services in location A. As a result, the user ends up using costly corporate WAN bandwidth between location A and location B. Moreover, in some situations, the user may receive a poorer quality of service than if the user had connected to the VPN gateway of location A due to additional latency or jitter introduced in the path over which the services are delivered.

Various embodiments of the present disclosure provide a method for optimized VPN routing between a remote access client 104 and a resource 120. This may be accomplished by dynamically selecting a VPN gateway 112 based on the optimality of the path between the VPN gateway and a resource 120 requested by remote access client 104. The remote access client 104 may then access the resource 120 through the selected VPN gateway 112. In some embodiments, the remote access client 104 establishes VPN tunnels 118 with multiple VPN gateways 112 that are each able to provide one or more resources 120 to remote access client 104 across optimal paths.

Particular embodiments utilize the unique position of the VPN gateways 112 as members of both the enterprise network 108 and network 116, which may be a public network. This enables them to select the VPN gateways 112 that are best suited to service a remote access client 104's connectivity needs and to dynamically instruct the remote access client 104 to establish VPN tunnels 118 to the selected VPN gateways 112. This results in a better user experience and increased application performance for remote access clients 104.

System 100 may include any suitable number of remote access clients 104 coupled to enterprise network 108 through network 116. A remote access client 104 is a device capable of communicating with resources 120 through a secure communications tunnel, such as VPN tunnel 118. For example, a remote access client 104 may be a computing device such as a server, personal computer, mobile device, or other appropriate computing device. In particular embodiments, remote access client 104 is a portable computing device that may connect to network 116 through any of various different access points. Remote access client 104 may include any collection of hardware, software, memory, and/or controlling instructions or logic operable to communicate with resources 120. As an example, remote access client 104 may include a software program, such as a VPN client, that facilitates the establishment of VPN tunnels 118 and the use of encrypted communication through VPN tunnels 118.

Enterprise network 108 represents a private network of an organization, such as a corporation, government, or other entity. In particular embodiments, enterprise network 108 is owned and/or controlled by the organization and access to enterprise network 108 is controlled by the organization. Enterprise network 108 includes any suitable number of interconnected resources 120 and networks 124 and 128. Networks 124 and 128 may include additional resources 120 of the enterprise network.

System 100 may include any suitable number of resources 120. In particular embodiments, at least a subset of resources 120 are each accessible through each of the VPN gateways 112. A resource 120 may be a computing device such as a server, network component, personal computer, mobile device, storage device, or other appropriate computing device. In the embodiment depicted, resource 120a is a Voice over Internet Protocol (VoIP) telephone, resource 120b is a hard drive, resource 120c is a desktop computer, resource 120d is a mail server, resource 120e is another desktop computer, and resource 120f is a laptop computer. Resources 120 may include any collection of hardware, software, memory, and/or controlling instructions or logic operable to provide applications or services to other resources 120 or remote access clients 104. In particular embodiments, enterprise network 108 also includes one or more resources that are located outside the enterprise network. For example, while remote access client 104 is connected via VPN tunnel 118 to the enterprise network 108, it may be considered a resource of the enterprise network 108. Accordingly, a remote access client 104 can access another remote access client 104 (e.g., via a communication session such as a voice, video, or other telepresence session) through one or more VPN gateways 112.

Enterprise network 108 may include any suitable number of smaller networks, such as networks 124 and network 128. Networks 124 of enterprise network 108 each represent any suitable network operable to facilitate communication between the components of system 100, such as remote access client 104, VPN gateways 112, and resources 120. Networks 124 may include any interconnecting system capable of transmitting audio, video, signals, data, messages, or any combination of the preceding. Each network 124 may include any suitable number of resources 120. In particular embodiments, network 124 may include one or more local area networks (LANs) or one or more subnetworks wherein the Internet Protocol (IP) address of a plurality of resources 120 of a subnetwork each have a common prefix (e.g., they may be included in the same classless inter-domain routing (CIDR) block).

Network 128 of enterprise network 108 represents any suitable network operable to facilitate communication between the components of system 100, such as remote access client 104, VPN gateways 112, and resources 120. Network 128 may include any interconnecting system capable of transmitting audio, video, signals, data, messages, or any combination of the preceding. Network 128 may include all or a portion of a public switched telephone network (PSTN), a public or private data network, a local area network (LAN), a metropolitan area network (MAN), a wide area network (WAN), a local, regional, or global communication or computing system network, such as the Internet, a wireline or wireless network, an enterprise intranet, or any other suitable communication link, including combinations thereof, operable to facilitate communication between the components of system 100.

In particular embodiments, network 128 is a private WAN that spans a large distance and couples networks 124 and VPN gateways 112 together. For example, network 128 may span across metropolitan, regional, or national boundaries. Network 128 may include high speed data lines owned, leased, and/or controlled by the enterprise. In some embodiments, network 128 may include public data lines wherein the lines are configured to securely transport data traffic between geographically dispersed networks 124 of the enterprise network 108.

System 100 may also include any suitable number of VPN gateways 112. VPN gateway 112 may include any collection of hardware, software, memory, and/or controlling instructions or logic operable to provide secure access to resources 120 of enterprise network 108. VPN gateway 112 may receive a request from a remote access client to establish a VPN tunnel 118. After authenticating (e.g., via a password or other method) and authorizing (e.g., determining what resources of enterprise network 108 the remote access client 104 is allowed to access) the remote access client 104, the VPN gateway 112 establishes a VPN tunnel 118 with the remote access client. The VPN tunnel 118 may be established using any suitable protocol, such as Internet Protocol Security (IPsec) or Secure Sockets Layer (SSL). VPN tunnel 118 is a secure communication tunnel across a network path wherein communication between the VPN gateway 112 and remote access client 104 is encrypted. VPN gateway 112 may receive encrypted communications from remote access client 104 through VPN tunnel 118, decrypt these communications, and forward them towards the destination resource 120 of enterprise network 108. VPN gateway 112 may also receive communications from a resource 120, encrypt these communications, and send the encrypted communications to remote access client 104 across VPN tunnel 118.

System 100 may also include a network 116 that couples remote access clients 104 to VPN gateways 112. Network 116 represents any suitable network operable to facilitate communication between the components of system 100, such as remote access client 104, VPN gateways 112, and resources 120. Network 116 may include any interconnecting system capable of transmitting audio, video, signals, data, messages, or any combination of the preceding. Network 116 may include all or a portion of a PSTN, a public or private data network, a LAN, a MAN, a WAN, a local, regional, or global communication or computing system network, such as the Internet, a wireline or wireless network, an enterprise intranet, or any other suitable communication link, including combinations thereof, operable to facilitate communication between the components of system 100.

As depicted in FIG. 1, system 100 includes various devices such as VPN gateways 112, remote access client 104, and resources 120. Any of these devices, such as VPN gateway 112a, may include one or more portions of one or more computer systems. In particular embodiments, one or more of these computer systems may perform one or more steps of one or more methods described or illustrated herein. In particular embodiments, one or more computer systems may provide functionality described or illustrated herein. In some embodiments, encoded software running on one or more computer systems may perform one or more steps of one or more methods described or illustrated herein and/or provide functionality described or illustrated herein.

The components of the one or more computer systems may comprise any suitable physical form, configuration, number, type, and/or layout. As an example, and not by way of limitation, one or more computer systems may comprise an embedded computer system, a system-on-chip (SOC), a single-board computer system (SBC) (such as, for example, a computer-on-module (COM) or a system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, one or more computer systems may be unitary or distributed, span multiple locations, span multiple machines, or reside in a cloud, which may include one or more cloud components in one or more networks.

In particular embodiments, a computer system may include a processor, memory, storage, and one or more communication interfaces. As an example, VPN gateway 112a comprises a computer system that includes one or more processors 130, memory 132, storage 140, and one or more communication interfaces 144. These components may work together in order to provide functionality described herein.

Processor 130 may be a microprocessor, controller, or any other suitable computing device, resource, or combination of hardware, stored software and/or encoded logic operable to provide, either alone or in conjunction with other components of VPN gateway 112a, VPN gateway functionality. In some embodiments, VPN gateway 112a may utilize multiple processors to perform the functions described herein.

Memory 132 and/or storage 140 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 132 and/or storage 140 may store any suitable data or information utilized by node 112a, including software embedded in a computer readable medium, and/or encoded logic incorporated in hardware or otherwise stored (e.g., firmware). For example, in the embodiment depicted, memory 132 stores VPN routing logic 136 that is operable, when executed, to perform one or more of the methods described herein. Memory 132 and/or storage 140 may also store the results and/or intermediate results of the various calculations and determinations performed by processor 130.

Communication interface 144 may be used for the communication of signaling and/or data between VPN gateway 112a and one or more networks and/or resources coupled to a network. Each communication interface 144 may send and receive data and/or signals according to a distinct standard such as Asynchronous Transfer Mode (ATM), Frame Relay, an Ethernet based standard (such as an IEEE 802.3 standard), or other suitable standard.

As described above, in particular embodiments, VPN gateways 112 are operable to perform optimized VPN routing for resources 120 requested by a remote access client 104. A VPN gateway 112 may receive a request through a VPN tunnel 118 from remote access client 104, identify a resource 120 referenced in the request, and select a VPN gateway that can optimally provide the resource 120. If the selected VPN gateway is the same as the VPN gateway 112 that received the request, the VPN gateway 112 may then provide the resource 120 to remote access client 104 (i.e. allow the remote access client to communicate with the resource). If the selected VPN gateway is different from the VPN gateway 112 that received the request, the VPN gateway 112 may send an indication of the selected VPN gateway to the remote access client 104 so that the remote access client may establish a VPN tunnel 118 with the selected VPN gateway and access the resource 120 through the selected VPN gateway and the newly established VPN tunnel. In order to accomplish this, various roles may be performed by the VPN gateways 112. For example, a VPN gateway 112 may serve as a designated VPN gateway, member VPN gateway, primary VPN gateway, and/or secondary VPN gateway.

In a particular embodiment, a VPN gateway of a group of VPN gateways 112 serves as a designated VPN gateway and the other VPN gateways 112 that are participating in optimal VPN routing serve as member VPN gateways. Each VPN gateway 112 calculates its own local route list and the member VPN gateways transmit their respective local route lists to the designated VPN gateway. The designated VPN gateway uses these local route lists to calculate a global route list. The designated VPN gateway then transmits the global route list to each member VPN gateway.

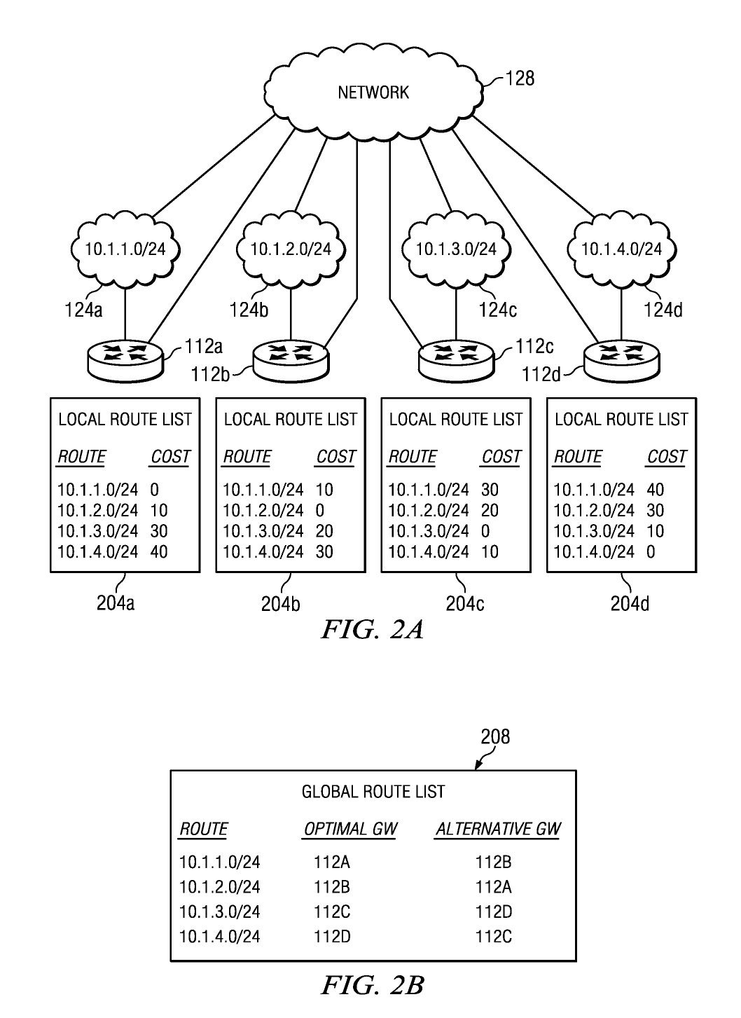

FIG. 2A depicts example local route lists 204 that may be generated by VPN gateways 112. A local route list 204 specifies the resources 120 that are reachable by the VPN gateway 112 that generated the local route list and the cost of reaching those resources from that VPN gateway 112. Each local route list 204 is unique to the VPN gateway 112 that creates it. A local route list 204 provides a partial map of the enterprise network 108 and when combined with the local route lists generated by other VPN gateways 112 enables selection from the VPN gateways of a least cost provider for a particular resource 120 of enterprise network 108.

The resources 120 that are listed in the local route lists 204 (e.g., resources that are reachable from VPN gateway 112) may be determined in any suitable manner. In particular embodiments, VPN gateway 112 includes or is coupled to a firewall that specifies addresses or summary routes (groups of addresses such as a CIDR block) to resources 120 of enterprise network 108. The resources 120 specified by the firewall may be included in entries of the local route list 204 of an associated VPN gateway 112. In some embodiments, some or all of the reachable resources 120 are manually specified (e.g., by a network administrator associated with the VPN gateway 112).

In the embodiment depicted, networks 124 each include a plurality of resources 120 of enterprise network 108. As an example, network 124a includes resources 120 with IP addresses that begin with 10.1.1 (i.e., resources 120 that have IP addresses CIDR block 10.1.1.0/24). Thus, a resource with an IP address of 10.1.1.1 or 10.1.1.147 may be included in network 124a. As other examples, network 124b includes resources 120 with IP addresses that begin with 10.1.2 (CIDR block 10.1.2/24), network 124c includes resources 120 with IP addresses that begin with 10.1.3 (CIDR block 10.1.3.0/24), and network 124d includes resources 120 with IP addresses that begin with 10.1.4 (CIDR block 10.1.4.0/24).

As depicted, the local route lists 204 generated by VPN gateways 112 each include a plurality of entries. For example, local route list 204a generated by VPN gateway 112a includes four entries. Each entry of a local route list 204 includes a resource 120 or a group of resources that are reachable by the VPN gateway 112. For example, local route list 204a includes four entries that each specify a group (i.e., a network 124) of resources 120 reachable by VPN gateway 112a. Each entry of the local route list 204a also includes a cost associated with communication between the VPN gateway 112a and the specified resource or any resource of the specified group of resources of the entry. For example, the first entry of local route list 204a indicates a cost of 0 for communicating with a resource of network 124a (i.e., a resource 120 that that has an IP address beginning with 10.1.1), the second entry of local route list 204a indicates a cost of 10 for communicating with a resource of network 124b (i.e., a resource 120 that that has an IP address beginning with 10.1.2), the third entry of local route list 204a indicates a cost of 30 for communicating with a resource of network 124c (i.e., a resource 120 that that has an IP address beginning with 10.1.3), and the fourth entry of local route list 204a indicates a cost of 40 for communicating with a resource of network 124d (i.e., a resource 120 that that has an IP address beginning with 10.1.4).

The costs specified in the local route lists 204 may be any suitable metric describing the path between the respective VPN gateway 112 and resource 120. Any suitable factor or combination of factors may used to calculate the cost that describes the path between the VPN gateway 112 and resource 120, such as an amount of time required to send data in either direction (or both directions) across the path, network latency or jitter associated with the path, bandwidth available on the path, the price of bandwidth used on the path, other cost related information obtained by a routing protocol, or any other suitable information. In particular embodiments, the costs of the local route lists 204 indicate the lengths of the paths (e.g., in distance or time) between the respective VPN gateways 112 and resources 120.

A cost may be identified in any suitable manner. For example, a cost may be manually entered (e.g. by an administrator associated with the VPN gateway 112), thus providing a high level of granularity and control. As another example, a cost may be calculated based on dynamic or static routing table cost information obtained through a particular routing protocol. This may involve translating the routing table cost information into a cost value that complies with a unified format, such that the cost value may be compared against other cost values that are translated from routing table cost information obtained through the use of other routing protocols.

FIG. 2B depicts an example global route list 208 that may be generated by a designated VPN gateway. After each member VPN gateway generates its own local route list 204, the local route lists are transmitted to the designated VPN gateway. The designated VPN gateway uses the received local route lists 204 in combination with its own local route list to generate global route list 208.

Global route list 208 includes a plurality of entries that each indicate the VPN gateway 112 that has the lowest cost of communication with a resource 120 or group of resources specified by the entry. In the embodiment depicted, each entry of global route list 208 specifies a group of resources 120, an optimal VPN gateway (e.g., the VPN gateway 112 that has the lowest cost of communication with the group of resources), and an alternative VPN gateway (i.e., the VPN gateway 112 that has the second lowest cost of communication with the group of resources). In the embodiment depicted, global route list 208 includes an explicit indication of the lowest cost VPN gateway for a given resource. In alternative embodiments, global route list 208 may include information that can be accessed to determine the lowest cost VPN gateway. For example, global route list 208 could include a compilation of some or all of the information included in local route lists 204.

After the global route list 208 is generated by the designated VPN gateway, it is sent to each member VPN gateway for use in selecting optimal VPN gateways to provide particular resources 120. The VPN gateways 112 may also be operable to detect changes in their respective local route lists 204 (e.g., changes to cost or reachability of a particular resource or group of resources) and communicate these changes to the designated VPN gateway in any suitable manner. The designated VPN gateway may analyze these changes, update global route list 208 if needed, and redistribute global route list 208 to the member VPN gateways.

VPN gateways 112 may use the global route list 208 to determine optimum VPN gateways 112 for providing various resources 120 of an enterprise network 108 to remote access clients 104. A VPN gateway 112 that notifies a remote access client 104 which VPN gateways to use for particular resources during a VPN session may be termed a primary VPN gateway and the other VPN gateways to which the remote access client is redirected may be termed secondary VPN gateways. Any gateway with a global route list 208 may perform as a primary VPN gateway for a particular VPN session with a remote access client 104. In addition to redirecting remote access client 104 to optimal VPN gateways for particular resources 120, the primary VPN gateway may also serve as the VPN gateway for all non-redirected and non-optimized traffic between remote access client 104 and enterprise network 108.

Referring back to FIG. 1, a VPN session begins as remote access client 104 requests a VPN tunnel 118a with VPN gateway 112a (the primary VPN gateway in this case). After authentication and authorization procedures are performed, VPN gateway 112a establishes VPN tunnel 118a with remote access client 104. Remote access client 104 then sends a request through VPN tunnel 118a to access a resource 120 of enterprise network 108. The request may be sent in any suitable manner. For example, the request may be included in one or more data packets, such as an IP packet. VPN gateway 112a examines the request to determine which resource 120 is requested. In particular embodiments, the request is encrypted and VPN gateway 112a decrypts the request and identifies an address (such as an IP address) of the requested resource 120 in the request.

VPN gateway 112a then examines global route list 208 to determine the optimal VPN gateway 112a for providing the resource 120. If VPN gateway 112a is the optimal VPN gateway for providing resource 120, then VPN gateway 112a provides access to the resource 120 through VPN gateway 112a. That is, communication between resource 120 and remote access client 104 passes through VPN gateway 112a. If the optimal VPN gateway specified by the global route list 208 is a different gateway (e.g., VPN gateway 112d), then VPN gateway 112a instructs the remote access client 104 to establish a VPN tunnel 118b with the other VPN gateway (e.g., VPN gateway 112d) to access resource 120. As an example, VPN gateway 112a may send an indication of which VPN gateway is the best gateway 112 to provide resource 120 to remote access client 104. In particular embodiments, VPN gateway 112a sends an IP address of the optimal VPN gateway to remote access client 104.

If the requested resource 120 is a member of a group of resources 120 specified by an entry of global route list 208 (e.g., the requested resource has an IP address of 10.1.4.2 and the entry of the global route list 208 is 10.1.4.0/24), VPN gateway 112a may notify remote access client 104 of the optimal VPN gateway for the entire group such that remote access client 104 may use that VPN gateway when requesting access to resources of that group (without first sending a request to VPN gateway 112a and being redirected to the optimal VPN gateway).

After acquiring an indication of the optimal VPN gateway for a particular resource, remote access client 104 requests VPN tunnel 118b with VPN gateway 112d (the secondary VPN gateway in this case). After authentication and authorization procedures are performed, VPN gateway 112d establishes VPN tunnel 118b with remote access client 104. In particular embodiments, remote access client 104 notifies VPN gateway 112d that VPN gateway 112d is a secondary VPN gateway for the VPN session with remote access client 104 (e.g., remote access client 104 may indicate that it already has a VPN tunnel with another VPN gateway 112a). In such embodiments, since VPN gateway 112d knows that another VPN gateway is serving as the primary VPN gateway, VPN gateway 112d does not need to check the global route list 208 or notify remote access client 104 of the optimal VPN gateway. After VPN tunnel 118b is established, remote access client 104 sends a request through VPN tunnel 118b to VPN gateway 112d to access resource 120 of enterprise network 108. Access to resource 120 is subsequently provided through VPN gateway 112d.

VPN tunnel 118a remains open while remote access client 104 accesses resource 120 through VPN tunnel 118b and VPN gateway 112d. Remote access client 104 may subsequently send any suitable number of requests for any suitable number of resources 120 through VPN tunnel 118a. VPN gateway 112a checks the destination resource 120 of each of these requests and provides the resource 120 or notifies remote access client 120 of the optimal VPN gateway for providing the resource. Remote access client 104 may establish a VPN tunnel 118 with any VPN gateway 112 to which it is redirected. Remote access client 104 may also reuse an open VPN tunnel 118. For example, a certain request may result in a notification from VPN gateway 112a that VPN gateway 112d is the best gateway to provide an additional resource 120. Remote access client 104 may then reuse VPN tunnel 118b to access the additional resource through VPN gateway 112d.

In particular embodiments, remote access client 104 stores the routes it uses so that the same routes may be used for future requests involving particular resources 120. For example, VPN client software executed by the remote access client 104 may install local specific routes on the remote access client 104 that point to the VPN tunnel 118 to be used to access particular resources. As an example, the local specific routes may indicate that 10.1.1.0/24 is reachable over a particular VPN tunnel 118a, while 10.1.4.7 is reachable over a different VPN tunnel 118b. Once a VPN tunnel 118 is terminated, the local specific routes associated with that tunnel may be removed.

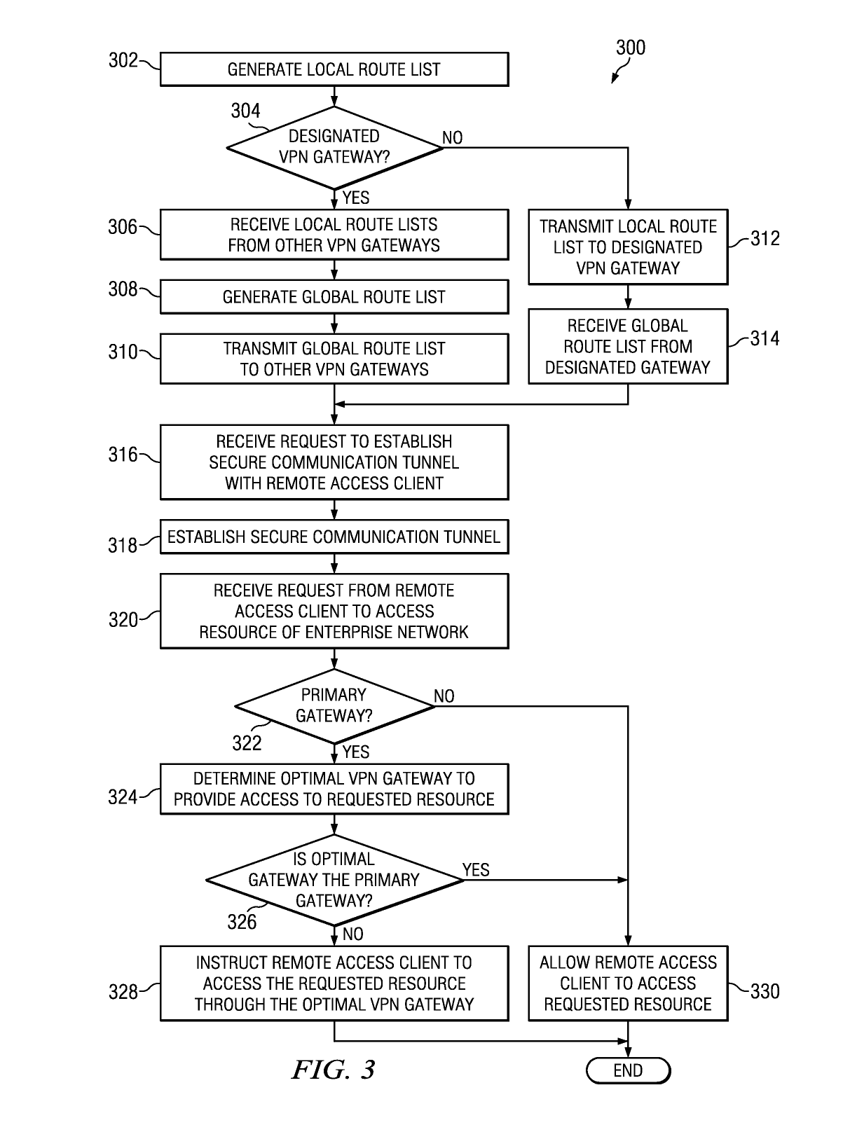

FIG. 3 depicts an example method 300 that may performed by the VPN gateways 112 of system 100 to provide optimized VPN routing. Method 300 begins at step 302 where VPN gateway 112 generates a local route list 204. The local route list 204 may include entries that specify one or more resources 120 of enterprise network 108 and a cost involved in communicating between the resource 120 and the VPN gateway 112. The costs specified in the local route list 204 may be represented in a unified format, such that the costs may be compared with costs specified in local route lists 204 generated by other VPN gateways 112. In particular embodiments, this includes translating, by the VPN gateway 112, routing table cost information into cost values that are included in the local route list 204 of VPN gateway 112.

At step 304, VPN gateway 112 determines whether it is the designated VPN gateway. If it is not, then VPN gateway 112 transmits the generated local route list 204 to the designated VPN gateway at step 312 and receives a global route list 208 from the designated VPN gateway at step 314. If the VPN gateway 112 is the designated VPN gateway, it receives local route lists 204 from the other VPN gateways at step 306. VPN gateway 112 then accesses these local route lists 204 and its own local route list and compiles a global route list 208 that indicates the optimal VPN gateway for each resource 120 (i.e., the VPN gateway 112 that can communicate with the resource at the lowest cost) reachable through VPN gateways 112. In particular embodiments, the global route list 208 also includes the second most optimal VPN gateway (i.e., an alternative VPN gateway) for each resource 120. The VPN gateway 112 then sends the global route list 208 to each of the other VPN gateways 112. In alternative embodiments, any suitable network element in communication with VPN gateways 112 may receive local route lists 204, generate global route list 208, and/or transmit global route list 208 to the VPN gateways 112.

In particular embodiments, a seed file used for password generation is sent with or separately from the global route list 208. Any suitable network element, such as the designated VPN gateway, may send the seed file to the VPN gateways 112. In some embodiments, clocks of the VPN gateways 112 are synchronized with each other such that passwords which have values dependent on the time they are generated are synchronized across the VPN gateways 112.

At step 316, a request to establish a secure communication tunnel with a remote access client 104 is received. The request may include information necessary for authentication and/or authorization of the remote access client 104. After authenticating and/or authorizing remote access client 104, VPN gateway 112 establishes a secure communication tunnel with remote access client 104. For example, a VPN tunnel 118 that carries encrypted communications may be established over a public network 116 between the VPN gateway 112 and the remote access client 104.

At step 320, VPN gateway 112 receives a request through the secure communication tunnel to access a resource 120 of enterprise network 108. At step 322, VPN gateway 112 may determine whether it is the primary VPN gateway for this request. In particular embodiments, the request received from the remote access client 104 indicates whether the VPN gateway 112 is the primary VPN gateway. If it is not the primary VPN gateway, VPN gateway 112 provides (i.e., allows the remote access client 104 to access) the requested resource 120 at step 330.

If VPN gateway 112 is the primary VPN gateway, it determines the optimal VPN gateway to provide access to the requested resource 120 at step 324. As an example, VPN gateway 112 may access global route list 208 and determine the VPN gateway 112 that has the lowest cost of communication with the requested resource 120. In particular embodiments, the determination of the optimal VPN gateway also includes factoring in the cost of communication between the remote access client 104 and one or more VPN gateways (including the VPN gateway that is chosen as the optimal VPN gateway). As an example, the remote access client 104 may determine a round trip time to communicate with each VPN gateway 112 and submit this information along with the request to access a resource 120. VPN gateway 112 may analyze this information along with the costs to communicate between the VPN gateways 112 and the resource 120 to determine the optimal VPN gateway.

At step 326, VPN gateway 112 determines whether it is the optimal VPN gateway. If it is, then VPN gateway 112 allows the remote access client 104 to access the requested resource 120 via VPN gateway 112 at step 330. If it is not, then VPN gateway 112 instructs the remote access client 104 to access the requested resource 120 through the optimal VPN gateway. For example, VPN gateway 112 may send an identification of the optimal VPN gateway to the remote access client 104. The remote access client 104 is operable to determine from this action that it should access the resource 120 via a different VPN gateway 112 (i.e., the optimal VPN gateway). The remote access client 104 then establishes a second secure communication tunnel with the optimal VPN gateway and accesses the requested resource 120 through this tunnel while maintaining the secure communication tunnel with VPN gateway 112 to use for additional requests.

In particular embodiments, after determining the optimal VPN gateway, VPN gateway 112 requests a one time password from the optimal VPN gateway. The optimal VPN gateway then generates the one time password using the seed file it received earlier. The one time password is included with the response from VPN gateway 112 to the remote access client 104. The remote access client 104 may then use the one time password to establish a secure communication channel with the optimal VPN gateway. This may allow the secure communication channel with the optimal VPN gateway to be established without additional involvement by the user of remote access client 104. This method may also provide better security than a static password or a dynamic shared key that is shared among all of the VPN gateways 112, since such a key may be vulnerable to extraction or dumping from a remote access client 104, replay attacks, or other unauthorized use. Additionally, re-key operations in such a scheme would be quiet intensive as they would involve all connected remote access clients 104 on all VPN gateways 112 simultaneously.

In another embodiment, after determining the optimal VPN gateway, VPN gateway 112 generates a one time password using the seed file and sends the password to the optimal VPN gateway and the remote access client 104. The remote access client 104 may then submit the one time password to the optimal VPN gateway in a request to establish a secure communication tunnel with the optimal VPN gateway. The optimal VPN gateway compares the password received from VPN gateway 112 to the password received from remote access client 104 and allows establishment of the secure communication tunnel if the passwords match.

In particular embodiments, if the secure communication tunnel with the optimal VPN gateway cannot be established, the remote access client 104 notifies VPN gateway of such. VPN gateway 112 may then provide an alternative VPN gateway (such as the VPN gateway with the second lowest cost of communication with the resource 120) or may provide the resource 120 itself. In some embodiments, VPN gateway may include an alternative VPN gateway (along with the optimal VPN gateway) in its response to the initial request from remote access client 104. Remote access client 104 may attempt to access resource 120 via the alternative VPN gateway before communicating the failure to VPN gateway 112.

In various embodiments, if a VPN tunnel 118 remains unused for a predefined amount of time, the VPN tunnel 118 is torn down. In addition, limits may be set on the number of VPN tunnels 118 a remote access client 104 is allowed to establish. In particular embodiments, if the limit is reached, the primary VPN gateway provides the requested resource 120 itself without redirecting remote access client 104 to the optimal VPN gateway.

In some embodiments, one or more features of the optimized VPN routing scheme described herein may be selectively enabled or disabled at the remote access client 104 before connecting the primary VPN gateway. If optimized VPN routing is disabled, remote access client 104 will generally establish a VPN tunnel 118 with a VPN gateway 112 and receive access to the resources 120 of the enterprise network 108 through that VPN gateway only. Moreover, in particular embodiments, application port numbers and/or particular protocols can be exempted from one or more features of the optimized VPN routing scheme described herein.

Modifications, additions, or omissions may be made to the systems, apparatuses, and methods disclosed herein without departing from the scope of the invention. The components of the systems may be integrated or separated. Moreover, the operations of the systems may be performed by more, fewer, or other components. Additionally, operations of the systems may be performed using any suitable logic comprising software, hardware, and/or other logic. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A first virtual private network (VPN) gateway comprising:
a memory configured to store computer executable instructions; and
one or more processors coupled to the memory, the processors configured, when executing the instructions, to:
receive a request from a remote access client to establish a first secure communication tunnel with the first VPN gateway, the first VPN gateway operable to communicate with a plurality of VPN gateways of an enterprise network, each VPN gateway operable to provide secure access to the same subset of a plurality of resources of the enterprise network;
establish the first secure communication tunnel between the remote access client and the first VPN gateway;
receive, through the first secure communication tunnel, a request from the remote access client to access a first resource of the subset of resources of the enterprise network;
access a global route list with a plurality of entries that each indicate a respective VPN gateway of the plurality of VPN gateways that has the lowest cost of communication with a respective resource of the subset of resources of the enterprise network;
select a second VPN gateway from the plurality of VPN gateways based, at least in part, on an entry of the global route list that indicates that the second VPN gateway has the lowest cost of communication with the first resource;
send an indication of the second VPN gateway to the remote access client;
maintain the first secure communication tunnel while the remote access client accesses the first resource of the enterprise network through a second secure communication tunnel established between the remote access client and the second VPN gateway; and
receive, through the first secure communication tunnel, one or more additional requests from the remote access client for one or more additional resources of the enterprise network.

2. The first VPN gateway of claim 1, wherein the cost of communication between the first resource and the second VPN gateway is based on an amount of time required to send or receive data from the second VPN gateway to the first resource.

3. The first VPN gateway of claim 1, wherein the selection of the second VPN gateway is further based on a cost of communication between the second VPN gateway and the remote access client.

4. The first VPN gateway of claim 1, the one or more processors further configured to generate a local route list, each entry of the local route list indicating a cost of communication between the first VPN gateway and a respective resource of the enterprise network, each cost of communication of the local route list determined by translating one or more values obtained through a routing protocol to a standard format.

5. The first VPN gateway of claim 1, the one or more processors further configured to:
receive a plurality of local route lists from the plurality of VPN gateways, each local route list comprising a plurality of entries associated with the VPN gateway from which the local route list was received, each entry comprising a cost of communication between the associated VPN gateway and a respective resource of the enterprise network; and
generating the global route list based on the local route lists.

6. The first VPN gateway of claim 5, the one or more processors further configured to transmit the global route list to each VPN gateway of the plurality of VPN gateways.

7. The first VPN gateway of claim 1, the one or more processors further configured to transmit, to the remote access client, a password that is valid for a limited time, the password required by the second VPN gateway for establishment of the second secure communication tunnel.

8. A method, comprising:
receiving a request from a remote access client to establish a first secure communication tunnel with a first Virtual Private Network (VPN) gateway of a plurality of VPN gateways of an enterprise network, each VPN gateway operable to provide secure access to the same subset of a plurality of resources of the enterprise network;
establishing the first secure communication tunnel between the remote access client and the first VPN gateway;
receiving, through the first secure communication tunnel, a request from the remote access client to access a first resource of the subset of resources of the enterprise network;
selecting a second VPN gateway from the plurality of VPN gateways based at least on a cost of communication between the first resource and the second VPN gateway;
sending an indication of the second VPN gateway to the remote access client; and
maintaining the first secure communication tunnel while the remote access client accesses the first resource of the enterprise network through a second secure communication tunnel established between the remote access client and the second VPN gateway.

9. The method of claim 8, wherein the cost of communication between the first resource and the second VPN gateway is based on an amount of time required to send or receive data from the second VPN gateway to the first resource.

10. The method of claim 8, wherein the selection of the second VPN gateway is further based on a cost of communication between the second VPN gateway and the remote access client.

11. The method of claim 8, further comprising generating a local route list, each entry of the local route list indicating a cost of communication between the first VPN gateway and a respective resource of the enterprise network, each cost of communication of the local route list determined by translating one or more values obtained through a routing protocol to a standard format.

12. The method of claim 8, further comprising:
receiving a plurality of local route lists from the plurality of VPN gateways, each local route list comprising a plurality of entries associated with the VPN gateway from which the local route list was received, each entry comprising a cost of communication between the associated VPN gateway and a respective resource of the enterprise network; and
generating a global route list based on the local route lists, each entry of the global route list indicating a respective VPN gateway of the plurality of VPN gateways that has the lowest cost of communication with a respective resource of the subset of resources of the enterprise network.

13. The method of claim 12, further comprising transmitting the global route list to each VPN gateway of the plurality of VPN gateways.

14. The method of claim 8, further comprising:
receiving a global route list at the first VPN gateway from a different VPN gateway of the plurality of VPN gateways; and
selecting the second VPN gateway from the plurality of VPN gateways based on an entry of the global route list that is associated with the first resource.

15. The method of claim 8, further comprising transmitting, by the first VPN gateway to the remote access client, a password that is valid for a limited time, the password required by the second VPN gateway for establishment of the second secure communication tunnel.

16. The method of claim 8, further comprising receiving, through the first secure communication tunnel, one or more additional requests from the remote access client for one or more additional resources of the enterprise network.

17. One or more tangible non-transitory media including logic that when executed is operable to:
receive a request from a remote access client to establish a first secure communication tunnel with a first Virtual Private Network (VPN) gateway of a plurality of VPN gateways of an enterprise network, each VPN gateway operable to provide secure access to the same subset of a plurality of resources of the enterprise network;
establish the first secure communication tunnel between the remote access client and the first VPN gateway;
receive, through the first secure communication tunnel, a request from the remote access client to access a first resource of the subset of resources of the enterprise network;
select a second VPN gateway from the plurality of VPN gateways based at least on a cost of communication between the first resource and the second VPN gateway;
send an indication of the second VPN gateway to the remote access client; and
maintain the first secure communication tunnel while the remote access client accesses the first resource of the enterprise network through a second secure communication tunnel established between the remote access client and the second VPN gateway.

18. The media of claim 17, wherein the cost of communication between the first resource and the second VPN gateway is based on an amount of time required to send or receive data from the second VPN gateway to the first resource.

19. The media of claim 17, wherein the remote access client is a first remote access client and the first resource is a second remote access client that has a third communication tunnel established with a VPN gateway of the plurality of VPN gateways of the enterprise network.

20. The media of claim 17, the logic further operable when executed to receive, through the first secure communication tunnel, one or more additional requests from the remote access client for one or more additional resources of the enterprise network.
